(19) United States
(12) Patent Application Publication
(10) Pub. No.: US 2014/0151337 A1
(43) Pub. Date: Jun. 5, 2014

(54) ELECTROMAGNETIC RELAY

(71) Applicant: FUJITSU COMPONENT LIMITED, Tokyo (JP)

(72) Inventors: Nobuyoshi Hiraiwa, Tokyo (JP); Yasushi Saito, Tokyo (JP); Kazutaka Nagamine, Tokyo (JP); Yuki Kakoiyama, Tokyo (JP); Yanfeng Wu, Tokyo (JP)

(73) Assignee: FUJITSU COMPONENT LIMITED, Tokyo (JP)

(21) Appl. No.: 14/232,798

(22) PCT Filed: Jun. 28, 2013
(86) PCT No.: PCT/JP2013/067909

§ 371 Date: Jan. 14, 2014

(30) Foreign Application Priority Data
Jul. 4, 2012 (JP) 2012-150644

(51) Int. Cl. H01H 33/18

(52) U.S. Cl. CPC H01H 33/182
USPC 218/26

(57) ABSTRACT

An electromagnetic relay which is improved in arc blocking performance without being increased in size is desired. An electromagnetic relay according to the present invention is provided with a fixed contact, a moving contact which is movable respect to the fixed contact, a pair of magnets which is arranged at the side of the fixed contact and the moving contact so that pole faces with mutually reversed polarity are separated from and face each other and a pair of arc cooling plates which is arranged in a spaces between the magnets and which has first surfaces which face each other across a gap and second surfaces which face a pole face of either of the magnets, respectively.

### TECHNICAL FIELD

The present invention relates to an electromagnetic relay.

### BACKGROUND ART

In an electromagnetic relay which is used inside a circuit of a high voltage battery of an electric vehicle or large-sized direct current device etc., sometimes the arc discharge which occurs at the time the contacts are opened (hereinafter simply referred to as an “arc”) causes the conduction state to be maintained and prevents the circuit from being broken. Further, even if the circuit is broken, the arc sometimes causes wear of contacts or melting of the contacts or other problems. Therefore, to secure the performance which is demanded from an electromagnetic relay which is used for a direct current high voltage circuit, it is essential to improve the arc extinguishing performance. Patent documents 1 to 4 disclose electromagnetic relays which are provided with devices for extinguishing the arcs which are generated at the time the contacts open or methods of extinguishing the arcs.

Patent document 1 discloses a method of extinguishing an arc which is generated in a space which is formed when a moving contact separates from a fixed contact when the moving contact and the fixed contact are opened (hereinafter referred to as a “contact gap”) by using permanent magnets to apply magnetic force in a perpendicular direction to the arc so as to pull the arc from a contact portion to a non-contact portion and thereby extend the arc length and smoothly cut the arc. However, with the method of Patent document 1, just the magnetic forces of permanent magnets are used to make the arc move from a contact portion to a non-contact portion, so the permanent magnets which are required for extinguishing the arc becomes larger and, along with this, the electromagnetic relay itself becomes larger in size.

Further, Patent document 2 discloses a plunger-type potential relay which has a ceramic plate chamber which faces a contact gap and which is provided by indentation, in the axial direction, of the surface of the inside wall of the housing present at a position perpendicular to the pole face of a permanent magnet and which has an arc resistance plate which has a ceramic as a material embedded in the ceramic plate chamber. With the method of Patent document 2, an arc-resistance plate is set at the place to which the arc moves, so sufficient stretching of the arc length is obstructed. Further, if arranging the arc resistance plate further separated from the contact gap so as to secure sufficient stretching of the arc length, the contact becomes larger in size.

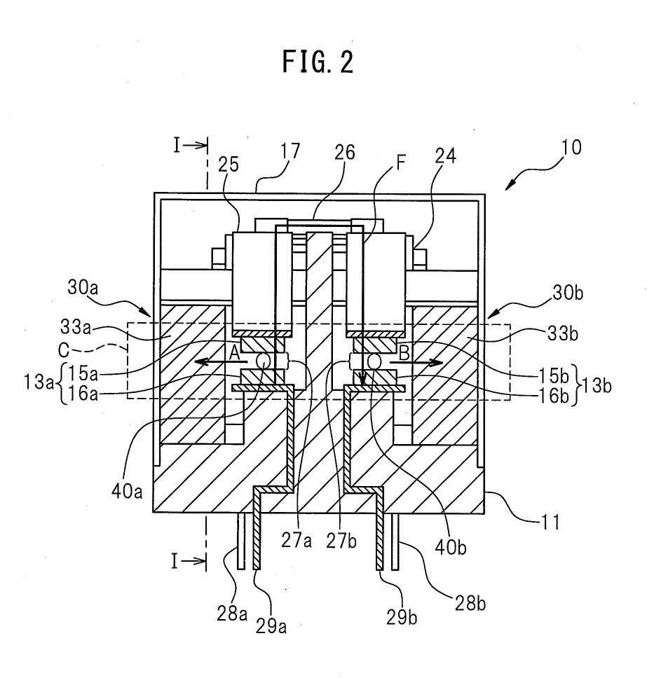

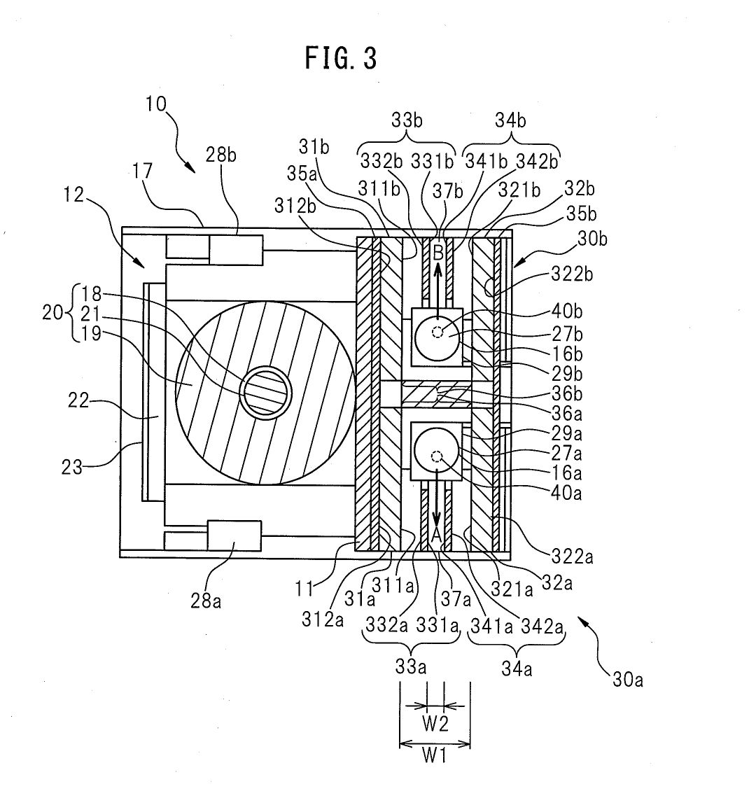

Patent document 3 discloses a sealed contact device which provides an arc extinguishing grid near a moving contact and a fixed contact. The arc extinguishing grid of the sealed contact device of this third patent literature is one where “several to several tens of 0.2 to 0.3 mm or so metal sheets are stacked. Between the individual metal sheets, there is a gap of several mm. These metal sheets, as shown in FIG. 3, are supported by support plates 38, 40 (39, 41) which are comprised of ceramic etc. and are arranged as shown in FIG. 2”. Support plates for superposition of the metal sheets with gaps between them become further necessary, so the contact becomes larger in size.

Patent document 4 discloses a sealed contact device which seals in hydrogen gas or another electrical insulating gas and operates the contact inside a hermetically formed sealed container. The cooling ability of the electrical insulating gas and the arc extinguishing action of permanent magnets which are arranged outside of the sealed container are used to quickly extinguish the generated arc. The method of Patent document 4 requires equipment for sealing in hydrogen gas or another electrical insulating gas. To prevent the electrical insulating gas from passing through, it is necessary to seal the container by a metal, ceramic, etc. Therefore, the cost rises.

### PRIOR ART DOCUMENT

### PATENT DOCUMENT

Patent document 1: Japanese Patent Publication No. 2002-334644A

Patent document 2: Japanese Patent Publication No. 7-235248A

Patent document 3: Japanese Patent Publication No. 6-22415A

Patent document 4: Japanese Patent Publication No. 6-22087B2

### SUMMARY

### Technical Problem

An electromagnetic relay which is improved in arc blocking performance without being increased in size is desired.

### Solution to Problem

The aspect of the invention which is set forth in claim 1 provides an electromagnetic relay which is provided with a fixed contact, a moving contact movable with respect to the fixed contact, a pair of magnets which is arranged at the side of the fixed contact and the moving contact so that mutually opposite pole faces are separated from and face each other and which pulls in an arc which is generated between the fixed contacts and the moving contact to a space between the pole faces, and a pair of arc cooling plates which are arranged in the spaces and which has first surfaces which face each other across a gap and second surfaces at the opposite sides to the first surfaces, which second surfaces face the pole faces of either of the magnets, an arc which is pulled into the space being pulled into the gap and contacting a first surface of at least one of the arc cooling plates.

The aspect of the invention which is set forth in claim 2 provides the electromagnetic relay as set forth in claim 1 wherein the pair of arc cooling plates is made of a ceramic.

The aspect of the invention which is set forth in claim 3 provides the electromagnetic relay as set forth in claim 1 or 2 wherein yokes are displaced adjacent to the surfaces of the pair of magnets at opposite sides to the pole faces.

The aspect of the invention which is set forth in claim 4 provides the electromagnetic relay as set forth in any one of claims 1 to 3 wherein the pair of arc cooling plates is arranged so that the gap becomes narrower further away from the fixed contact and the moving contact.

### Effects of the Invention

In the electromagnetic relay according to the present invention, between pole faces an arc which is pulled into a space between pole faces contacts the first surface of at least one of the arc cooling plates. For this reason, arcs which are generated by fixed contacts and moving contacts are cooled and extinguished by contact with the arc cooling plates. Further, high temperature arcs are extinguished by contact with arc cooling plates in the stretched state, so the loads on the arc cooling plates become smaller and it is possible to prevent damage to the arc cooling plates by the arcs.

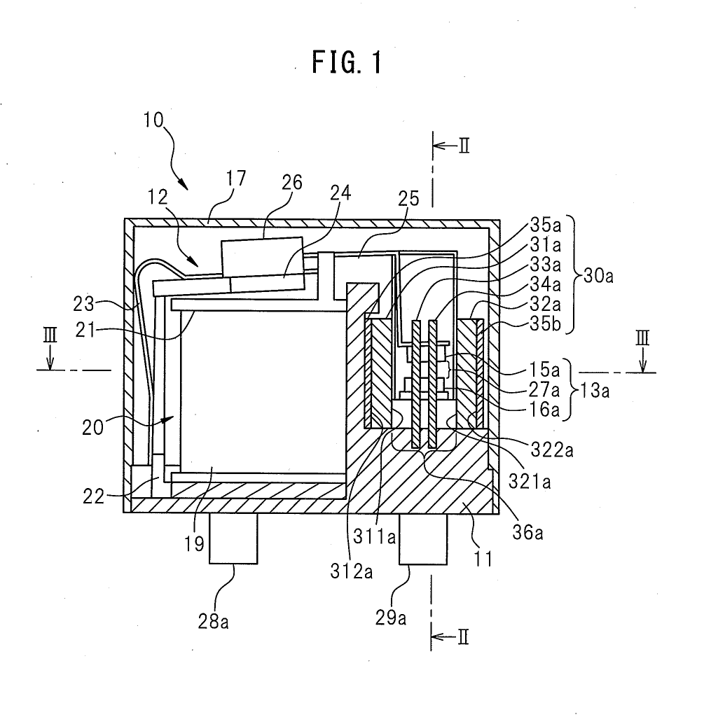

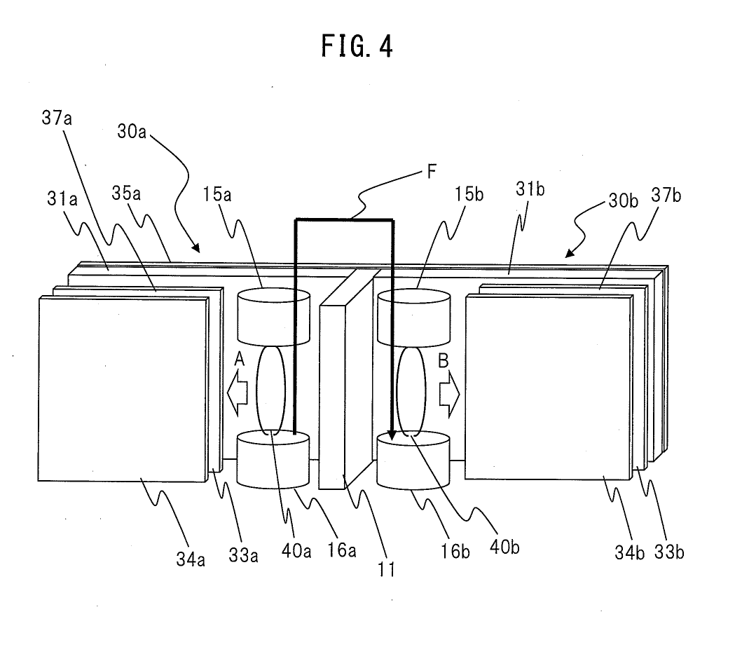

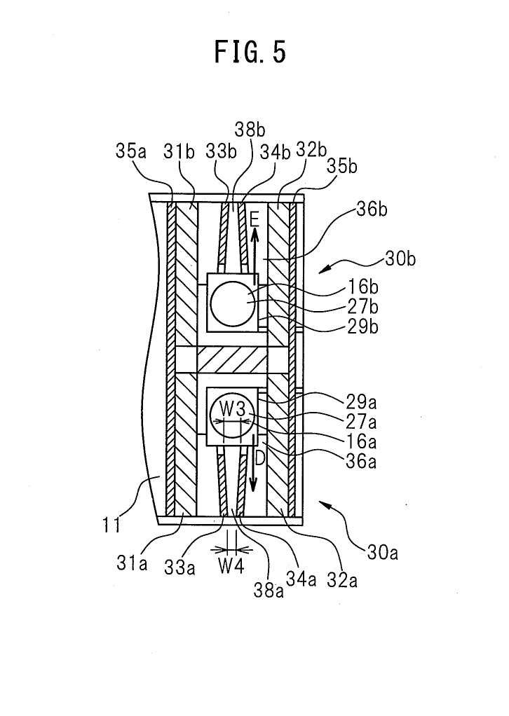

### BRIEF DESCRIPTION OF THE DRAWINGS

[FIG. 1] A cross-sectional view showing an electromagnetic relay according to an embodiment of the present invention

[FIG. 2] A cross-sectional view along the line II-II of FIG. 1

[FIG. 3] A cross-sectional view along the line III-III of FIG. 1

[FIG. 4] A perspective view showing part of the electromagnetic relay enlarged

[FIG. 5] A plan view showing another example of an arc extinguishing part of an electromagnetic relay.

### DESCRIPTION OF EMBODIMENTS

Below, the attached figures will be referred to so as to explain the embodiments of the present invention. In the following embodiments, the same or similar members are shown assigned common reference signs. Further, it should be noted that the technical scope of the present invention is not limited to these embodiments and extends to the inventions which are described in the claims and their equivalents.

FIG. 1 is a cross-sectional view which shows the configuration of an electromagnetic relay 10 according to an embodiment of the present invention, FIG.

2 is a cross-sectional view along the line II-II of FIG. 1, and FIG. 3 is a cross-sectional view along the line III-III of FIG. 1. The electromagnetic relay 10 of the present embodiment comprises a base 11, an electromagnet block 12, contacts 13a, 13b (hereinafter sometimes collectively referred to as “contacts 13”) which include two fixed contacts 16a, 16b (hereinafter sometimes together referred to as “fixed contacts 16”) and moving contacts 15a, 15b (hereinafter sometimes together referred to as “moving contacts 15”) which move with respect to the fixed contacts 16a, 16b and contact the fixed contacts 16a, 16b, arc extinguishing parts 30a, 30b which extinguish arcs which are generated at the contacts 13a, 13b, and a cover 17 which encloses the electromagnet block 12, contacts 13, and arc extinguishing parts 30a, 30b.

The electromagnet block 12 comprises a yoke 22 which is arranged on the base 11, an electromagnet 20, a hinge spring 23, an armature 24 which is provided at the front end of the hinge spring 23, and an insulator 26 which is arranged on the armature 24. The electromagnet 20 comprises a bobbin 21, a coil 19 which is wound around the outer circumference of the bobbin 21, and a core 18 which is arranged at the inner circumference of the bobbin 21. Further, at the bottom of the base, coil terminals 28a, 28b which extend from the coil 19 are provided. Note that, the illustrated configuration of the electromagnet block 12 is one example. The electromagnet block may also be configured in other ways.

The contacts 13 include two moving contacts 15a, 15b and fixed contacts 16a, 16b as explained above. The moving contacts 15a, 15b are fastened to a moving spring 25 which moves linked together with the armature 24. Further, at the bottom of the base 11, fixed terminals 29a, 29b which are linked with one of the fixed contacts 16a, 16b respectively are provided (see FIG. 2).

By the electromagnet 20 of the electromagnet block 12 being excited or demagnetized and a movement of the armature 24, the moving spring 25 moves linked together with the armature 24, and the moving contacts 15 and the fixed contacts 16 contact or separate. When the armature 24 descends and the moving contacts 15 and the fixed contacts 16 contact, current flows, for example, in the arrow F direction of FIG. 2 from the fixed terminal 29a to pass through the contacting fixed contact 16a and moving contact 15a, passes via the moving spring 25 through the contacting moving contact 15b and fixed contact 16b, and reaches the fixed terminal 29b.

By the moving spring 25 rising in the upward direction in FIG. 2, the moving contacts 15a, 15b move upward and the moving contacts 15a, 15b and fixed contacts 16a, 16b separate, respectively. Due to this separation, as shown in FIG. 2, contact gaps 27a, 27b are formed between the contacts and the current which flows in the arrow F direction is cut off. However, when the moving contacts 15 and the fixed contacts 16 separate, sometimes arcs 40a, 40b (hereinafter sometimes collectively referred to as “arcs 40”) are generated at the contact gaps 27a, 27b.

The arc extinguishing parts 30a, 30b which the electromagnetic relay 10 of the present embodiment is provided with will be explained with reference to FIG. 1, FIG. 3, and FIG. 4. FIG. 4 is a perspective view which enlarges the part C surrounded by the broken line in FIG.

2 and shows the arc extinguishing parts 30a, 30b, but part of the components are omitted so as to show the structures of the arc extinguishing parts 30a, 30b.

The electromagnetic relay 10 of the present embodiment is provided with two arc extinguishing parts 30a, 30b so as to extinguish the arcs 40a, 40b which are generated at two contact gaps 27a, 27b. The arc extinguishing part 30a and the arc extinguishing part 30b only differ in direction in which the arcs 40 are stretched by the magnetic field. The rests of the configurations are substantially the same.

The arc extinguishing part 30a, as shown in the drawing, is provided with a pair of permanent magnets 31a, 32a of plate shapes. The permanent magnets 31a, 32a are arranged so as to be separated from and face each other at the sides of the moving contact 15a and fixed contact 16a across the contact gap 27a so that each polarity of the pole faces 311a, 321a which face each other becomes opposite, in other words, N-pole face of one permanent magnet and S-pole face of the other permanent magnet face each other.

By having the reversed pole faces of the pair of permanent magnets 31a, 32a which face each other, arranged facing each other across a certain interval W1, a magnetic field is generated in a space 36a. Since a magnetic field is generated in the space 36a, a Lorentz force acts on the arc 40a generated by the current flowing from the fixed contact 16a to the moving contact 15a, the arc 40a is stretched in the arrow A direction, and the arc 40a is pulled into the space 36a. p The arc extinguishing part 30a is provided with a pair of arc cooling plates 33a, 34a. The pair of arc cooling plates 33a, 34a has first surfaces 331a, 341a which face each other across a gap 37a and second surfaces 332a, 342a at the opposite sides of the first surfaces 331a, 341a. Further, the second surface 332a of the arc cooling plate 33a faces the pole face 311a of the permanent magnet 31a, while the second surface 342a of the arc cooling plate 34a faces the pole face 321a of the permanent magnet 32a.

As shown in FIG. 1 and FIG. 3, the pair of arc cooling plates 33a, 34a is arranged inside the space 36a between the permanent magnets 31a, 32a while facing each other across a gap 37a of a certain interval W2 so as to sandwich the arc 40a which is generated at the contact gap 27a and which is stretched by the magnetic forces of the pair of permanent magnets 31a, 32a. The arc 40a which is stretched by the permanent magnets 31a, 32a and is pulled into the space 36a is pulled inside of the gap 37a of the pair of arc cooling plates 33a, 34a.

In the illustrated embodiment, the pair of arc cooling plates 33a, 34a is arranged to become substantially parallel to the permanent magnets 31a, 32a. The arc cooling plates 33a, 34a are arranged across the gap 37a so as to sandwich the stretched arc 40a, so the stretching of the arc 40a is not obstructed much at all. The arc 40a which is pulled into the gap 37a is cooled and extinguished by contacting at least one of the mutually facing first surfaces 331a, 341a of the arc cooling plates 33a, 34a. The arc 40a is high in heat, so if striking the cooling plates 33a, 34a, the arc cooling plates 33a, 34a may be damaged by the heat of the arc 40a. In the configuration of the present embodiment, the arc 40a is stretched and cooled to a certain extent inside the space 36a, then contacts the arc cooling plates 33a, 34a inside the gap 37a, so damage to the arc cooling plates 33a, 34a can be prevented. The arc cooling plates 33a, 34a of the illustrated embodiment are made of ceramic, so their effect on the magnetic field inside the space 36a is small. Even after the arc 40a is pulled into the gap 37a of the arc cooling plates 33a, 34a, it is stretched by the magnetic field.

Further, at the surfaces 312a, 322a of the permanent magnets 31a, 32a at the opposite sides to the pole faces 311a, 321a, as shown in FIG. 1 and FIG. 3, yokes 35a, 35b are set. By setting the yokes 35a, 35b at the surfaces 312a, 322a of the permanent magnets 31a, 32a, a uniform magnetic field is obtained at the space 36a. In the illustrated embodiment, the contact gap 27a is offset in position from the center part of the space 36a, but by arranging the yokes 35a, 35b, even at the position of the contact gap 27, a uniform magnetic field is obtained in the same way as the center part of the space 36a, the strength of the magnetic forces which are applied to the arc 40a which is generated at the contact gap 27a increase, and the arc 40a can be stretched more stably.

Note that, the pair of permanent magnets 31a, 32a need only be arranged in proximity to the contact gap 27a. They do not necessarily have to be arranged so as to sandwich the contact gap 27a so long as the arc 40a can be pulled into the space 36a. However, if the pair of permanent magnets 31a, 32a are arranged so as to sandwich the contact gap 27, the magnetic field becomes stronger and the arc 40a can be more stably pulled into the space 36a, so this is preferable. Further, the permanent magnets 31a, 32a are examples of the magnets. For example, electromagnets may also be used to generate the magnetic field.

The other arc extinguishing part 30b, as shown in FIG. 3, is provided with a pair of permanent magnets 31b, 32b of plate shapes which are arranged so as to be separated from and face each other at the sides of the moving contact 15b and fixed contact 16b across the contact gap 27b so that the polarities of the pole faces 311b, 321b become opposite (so that N-pole face and S-pole face face each other).

By having the mutually opposite pole faces 311b, 321b of the pair of permanent magnets 31b, 32b arranged facing each other across a certain interval W1, a space 36b is formed in which a magnetic field is generated. Since the magnetic field is generated in the space 36b, a Lorentz force acts on arc 40b of the current flowing from the moving contact 15b to the fixed contact 16b which was generated at the contact gap 27b, the arc 40b is stretched in the arrow B direction, and the arc 40b is pulled into the space 36b.

The arc extinguishing part 30b is provided with a pair of arc cooling plates 33b, 34b. The pair of arc cooling plates 33b, 34b has first surfaces 331b, 341b which face each other across a gap 37b and second surfaces 332b, 342b at opposite sides to the first surfaces 331b, 341b. Further, the second surface 332b of the arc cooling plate 33b faces the pole face 311b of the permanent magnet 31b, while the second surface 342b of the arc cooling plate 34b faces the pole face 321b of the permanent magnet 32b.

As shown in FIG. 3, the pair of arc cooling plates 33b, 34b are arranged facing each other across a predetermined interval W2 inside a space 36b between the permanent magnets 31b, 32b so as to form a contact gap 27b and sandwich an arc 40b which is stretched by the magnet forces of the pair of permanent magnets 31b, 32b. Further, the pair of arc cooling plates 33b, 34b are arranged so as to become substantially parallel to the permanent magnets 31b, 32b. The arc 40b which is stretched by the magnetic field of the permanent magnets 31b, 32b, is pulled into the space 36b, and is pulled into the gap 37b of the first surface 331b of the arc cooling plate 33b and the arc cooling plate 34b is cooled and extinguished by contacting at least one of the first surface 331b of the arc cooling plate 33b and the first surface 341b of the arc cooling plate 34b.

At the surfaces 312b, 322b of the permanent magnets 31b, 32b at the opposite sides to the space 36b, as shown in FIG. 3, yokes 35a, 35b are arranged. By arranging the yokes 35a, 35b at the outside surfaces 312b, 322b of the permanent magnets 31b, 32b, a uniform magnetic field is obtained at the space 36b. By arranging the yokes 35a, 35b, a uniform magnetic field is obtained at the contact gap 27b as well in the same way as the center part of the space 36b, the strength of the magnetic forces which are applied to the arc 40b which is generated at the contact gap 27b is increased, and the arc 40b can be stretched more stably. Note that, in the illustrated embodiment, the arc extinguishing part 30a and the arc extinguishing part 30b share the yokes 35a, 35b, but separate yokes may also be provided.

Note that, the electromagnetic relay 10 of the illustrated embodiment is configured so as to extinguish the arcs 40a, 40b which are generated at the two contact gaps 27a, 27b, but it may also be configured so that only one of the contact gaps is provided with an arc extinguishing part for extinguishing an arc.

The material of the arc cooling plates is preferably a ceramic in consideration of the insulation and heat resistance. However, the material for arc cooling use is not limited to this. When the heat resistance in the case of contact with the arc is sufficiently secured, another material, for example, a heat resistant plastic, may also be used for forming the plates.

In the arc extinguishing parts 30a, 30b which are shown in FIGS. 1 to 4, the pairs of arc cooling plates 33a, 34a and arc cooling plates 33b, 34b were arranged so as to become mutually parallel at a certain interval W2. However, the method of arranging the arc cooling plates 33a, 34a, 33b, 34b is not limited to this.

For example, as shown in FIG. 5, the arc cooling plates may be arranged so that the widths of the intervals between the facing pairs of arc cooling plates become narrower the further from the contact gaps 27a, 27b, in other words, so that compared with the interval W3 between the arc cooling plate 33a and the arc cooling plate 34a near the contact gap 27a, the interval W4 between the arc cooling plate 33a and the arc cooling plate 34a positioned the furthest from the contact gap 27a becomes smaller. In the spaces 36a, 36b, due to the heat at the time when the arcs 40a, 40b are generated, the air around the contact gaps 27a, 27b is warmed. A temperature difference with respect to the air of the outsides 38a, 38b of the spaces 36a, 36b is formed, so a pressure difference is formed between spaces 36a, 36b and spaces 38a, 38b and the air inside of the spaces 36a, 36b flows in the arrow D direction or arrow E direction of

FIG. 5. Furthermore, by narrowing the gap between the arc cooling plates 33a, 34a or the gap between the arc cooling plates 33b, 34b, the flow of air becomes faster and the arcs 40a, 40b can be stretched more to extinguish them. That is, by stretching the arcs 40a, 40b which are generated at the contact gaps 27a, 27b to the narrower width spaces (outsides 38a, 38b), due to the Venturi effect (an effect of ejecting the fluid, such as air or liquid, out of the small tube by a pressure differential, when running fluid to the small tube from a wide space), the flow rate of the surrounding air increases and the arcs 40a, 40b can be stretched more.

Above, drawings were used to explain the electromagnetic relay according to the present embodiment. Like the prior art, when using only magnets to extinguish arcs, a certain amount of space was necessary for making the arcs naturally extinguish, but like the electromagnetic relay according to the present embodiment, by using arc cooling plates, it is possible to reduce the spaces between the pole faces, i.e., the arc extinguishing part provided at the electromagnetic relay of the present embodiment is comprised of arc cooling plates which are arranged facing each other so as to sandwich a stretched arc between them, so it is possible to extinguish an arc without impairing the stretching of the arc. By providing the pair of arc cooling plates in the space of a magnetic field which is formed by magnets, it is possible to further reduce the size of the space for extinguishing the arc. The electromagnetic relay is not increased in size. Further, the electromagnetic relay according to the present embodiment does not use hydrogen gas or another inert gas for an arc cooling effect, so there is no need to make the surroundings of the contacts of the electromagnetic relay hermetically sealed and inexpensive production is possible. In other words, a configuration for sealing in the gas is not required and inexpensive production of an electromagnetic relay which is improved in arc blocking performance becomes possible.

### DESCRIPTION OF REFERENCE SIGNS

10 Relay

12 Electromagnet block

13a, 13b Contact

15a, 15b Moving contact

16a, 16b Fixed contact

30a, 30b Arc extinguishing part

31a, 32a, 31b, 32b Permanent magnet

33a, 34a, 33b, 34b Arc cooling plate

35a, 35b Yoke

1-4. (canceled)

5. An electromagnetic relay comprising:
a fixed contact;
a moving contact movable with respect to said fixed contact;
a pair of magnets which is arranged at the side of said fixed contact and said moving contact so that pole faces with mutually reversed polarity are separated from and face each other; and
a pair of arc cooling plates which is arranged in a space between said magnets and which has first surfaces which face each other across a gap and second surfaces which face a pole face of either of said magnets, respectively.

6. The electromagnetic relay according to claim 5, wherein said arc cooling plates are made of a ceramic.

7. The electromagnetic relay according to claim 6, wherein yokes are disposed adjacent to the surfaces opposite to pole faces of said pair of magnets which face each other.

8. The electromagnetic relay according to claim 7, wherein said pair of arc cooling plates is arranged so that said gap becomes narrower further away from said fixed contact and said moving contact.

9. The electromagnetic relay according to claim 6, wherein said pair of arc cooling plates is arranged so that said gap becomes narrower further away from said fixed contact and said moving contact.

10. The electromagnetic relay according to claim 5, wherein yokes are disposed adjacent to the surfaces opposite to pole faces of said pair of magnets which face each other.

11. The electromagnetic relay according to claim 10, wherein said pair of arc cooling plates is arranged so that said gap becomes narrower further away from said fixed contact and said moving contact.

12. The electromagnetic relay according to claim 5, wherein said pair of arc cooling plates is arranged so that said gap becomes narrower further away from said fixed contact and said moving contact.
